(19) United States
(12) Patent Application Publication
(10) Pub. No.: US 2015/0360408 A1
(43) Pub. Date: Dec. 17, 2015

(54) SELF-HEALING SYSTEM COMPRISING LOGITUDINAL NANO/MICROSTRUCTURES AND METHOD OF PRODUCTION THEREOF

(71) Applicant: SABANCI UNIVERSITESI, Istanbul (TR)

(72) Inventors: Yusuf Ziya Menceloglu, Istanbul (TR); Burcu Saner Okan, Istanbul (TR); Mehmet Yildiz, Istanbul (TR); Melih Papila, Istanbul (TR); Volkan Özgüz, Istanbul (TR)

(21) Appl. No.: 14/306,839

(22) Filed: Jun. 17, 2014

(51) Int. Cl. B29C 47/00

(52) U.S. Cl. CPC B29C 47/0076; B29K 2063/00

(57) ABSTRACT

A self-healing system of nano/microstructures comprising a first type 1 and a second type 2 of longitudinal nano/microstructures each having an outer surface 100, each having a core 10, 11 and a polymeric first layer 20, 21 coaxially surrounding said core 10, 11 and at least one of said longitudinal nano/microstructure comprising a catalyst 101, wherein the core 10 of said first type nano/microstructures 1 comprises an epoxy resin, and the core 11 of said second type nano/microstructures 2 comprises a hardener, each of said first and second type nano/microstructures further comprise a second layer 30, 31 coaxially surrounding said first layer 20, 21 wherein the stiffness of said second layer 30, 31 is higher than the stiffness of said first layer 20, 21, and said hardener reacts with said epoxy resin when said first layer 20, 21 and second layer 30, 31 of said first and second type of nano/microstructures 1, 2 rupture upon a mechanical damage. A self-healing composite structure comprising said system is further provided. Also a method for obtainment of such nano/microstructures and system is provided.

### TECHNICAL FIELD OF THE INVENTION

The present invention relates to a self-healing system comprising longitudinal nano/microstructures with high stiffness; and a production method thereof.

### BACKGROUND OF THE INVENTION

Self-healing materials are considered as a class of smart materials capable of autonomic healing when damaged due to the thermal, mechanic, ballistic or other external interventions. These materials are to be employed in energy, medical, textile, automotive, aerospace, construction and filtration applications. In order to minimize the damage in the materials, there are several attempts to develop new healing agents.

Some of the important parameters affecting the self-healing mechanisms involving polymeric systems are shelf-life, viscosity of monomers, volatility, reaction rate and shrinkage. When a structural polymer is subjected to instant, intermittent and/or continuous stress and deformation, cracks may occur in the structure and thus mechanical degradation starts. Therefore, self-healing materials are developed in order to stabilize the mechanical integrity of the structure. These materials automatically repair the damaged zone and show resistance to further external interventions. Among these materials, microcapsules are commonly utilized as self-healing agents in various matrices. Said microcapsules generally suffer from low strength shell walls, large size distribution and uncontrolled release of capsule contents. In WO 02 064 653, an autonomic repair mechanism is achieved by the incorporation of a microcapsulated healing agent (dicyclopentadiene monomer) and Grubbs' catalyst in epoxy matrix. Pan coating, spray drying, centrifugal extrusion, and emulsification are widely used techniques for the synthesis of microcapsules. However, there are several drawbacks in the encapsulation process of healing agents which are large size distribution, low strength shell walls, poor structural integrity and limited triggering capabilities (doi: 10.1021/ma201014n). Polymeric capsules have several drawbacks such as difficult encapsulation process, poor structural integrity, low strength of shell walls, shape changes and uncontrolled release of capsule contents. Due to these obstacles, self-healing fibers are designed to repair damaged zones. In contrast to microcapsules, fibers provide chemical compatibility and structural integrity.

There are also some attempts of utilization of self-healing fibers as reinforcing agents in matrix materials, but lack of stiffness is the main obstacle in fiber-type healing agents. Therefore, electrospun fibers are considered to be more advantageous in comparison with hollow fibers in fiber reinforced composites. Currently, few studies are available about fabrication of self-healing nanofibers, wherein are single- or double-walled nanofibers are produced by classical or co-axial electrospinning techniques. At the classical technique, healing agents are filled into pores of hollow fibers and physically trapped by capillary forces. However, the leakage of healing agents through the fiber walls, and difficulty of closing the ends of fibers are considered as the main drawbacks of said techniques.

U.S. Pat. No. 5,989,334 describes the preparation of hollow macrofibers as self-healing reinforcing agents in cement matrix. Said healing agent is filled into hollow fibers by an additional process and retained through the walls by capillary forces and closing off the end of fibers. However, a self-healing efficiency provided by these fibers is available only in macro scale. In another work, single walled electrospun fibers are embedded in epoxy matrix, for improving mechanical properties of these composites (doi: 10.1021/am100288r). Also, optical Fiber Bragg Grating (FBG) sensors are embedded with the fibers in the matrix during composite preparation by resin transfer molding (RTM) technique and thus fabrication process and structural health changes are observed with these sensors (doi: 10.1177/0731684411411960). Additionally, fabrication of electrospun composite fibers, their integration into traditional laminated structural composites as toughening interlayers and continuous monitoring, inspection and damage detection thereof is also currently a subject of research interest (doi: 10.1115/1.4006770, doi: 10.1021/am2014162 doi: 10.1016/j.compscitech.2012.07.005, doi: 10.1016/j.compositesa.2013.12.001).

One dimensional (ID) structures such as fibers and hollow fibers have a great potential in a wide range of applications. In the last decade, core/shell fibers have attracted great attention due to the improvement of material property profiles. The first related work is the obtainment of core/shell nano-/mesofibers by co-electrospinning of two materials (doi: 10.1002/adma.200305136). In said work, two liquid streams which are polymer solutions or a combinations of polymer solutions and a melt flow out of a system comprising a core-nozzle and a surrounding nozzle. Said work carries importance in the reduction of the diameters into nanometers. In another work, hollow nanofibers having functionalized inner and outer surfaces are produced by co-electrospinning with a coaxial, dual-capillary spinneret (doi: 10.1002/smll.200400056). In another work, a liquid healing agent is encapsulated in beads by coaxial electrospinning and self-healing polymer coating systems based on these coaxial electrospun nanofibers (doi: 10.1002/adma.200902465) and self-healing polymer coating systems based on an electrospun coaxial healing agent are described, and the effectiveness of co-axial electrospinning technique on autonomic healing of polymer coatings are mentioned. Yet, it is very difficult to provide stiffness to the bead surfaces for keeping the materials inside the beads when a minor force is applied on said coating system.

U.S. Pat. No. 8,309,479 B2 demonstrates the preparation of metal-coated polymer nanofibers by electrospinning technique. In this patent, electrospun nanofibers are modified by epoxy rings and then metal nano-particles are deposited on the fibers after reduction by hydrazine. The catalysts are deposited on the outer surface of electrospun nanofibers by this technique.

The leakage of healing agents from the fibers is the main obstacle in the encapsulation of healing agent in a fiber structure. Other important limitations in the fabrication of self healing core/shell nanofibers are fast solvent evaporation, strong deformation and non-ordered/inappropriate formation during electrospinning process. During the electrospinning process, wall materials can react with each other and non-ordered wall formation can be observed. The healing agent should remain inert in the fiber structure unless fiber is damaged.

In the self-healing systems according to the prior art, fiber reinforced composites contain hollow fibers having a healing agent but these composites suffer from low stiffness due to liquid cores of said fibers. Also, tensile strengths and fatigue lives of the materials have significantly low values. In case of formation of a crack, healing agent containing hollow fibers release healing agent into the damaged area. At the end of the healing process, mechanical integrity of said fibers is further decreased in comparison with the mechanical integrity prior to damage.

Additionally, the mechanical stability of self-healing core-shell systems according to the prior art tends to significantly decrease with increasing core diameters; since it is the stiffness provided by said shells is difficult to keep high amount of liquid inside core, without an extra support provided from outside.

### OBJECTS OF THE INVENTION

Primary object of the present invention is to overcome the abovementioned shortcomings of the prior art.

Another object of the present invention is to provide coaxially multilayered longitudinal nano/microstructures with enhanced stiffness.

Yet another object of the present invention is to provide a self-healing system having enhanced stability and self-healing behavior.

Further an object of the present invention is to provide a method to obtain such self-healing system.

### SUMMARY OF THE INVENTION

A self-healing system of nano/microstructures comprising a first type and a second type of longitudinal nano/microstructures each having an outer surface, each having a core and a polymeric first layer coaxially surrounding said core and at least one of said longitudinal nano/microstructures comprising a catalyst, wherein the core of said first type nano/microstructures comprises an epoxy resin, and the core of said second type nano/microstructures comprises a hardener; each of said first and second type nano/microstructures further comprise a second layer coaxiatly surrounding said first layer wherein the stiffness of said second layer is higher than the stiffness of said first layer, and said hardener reacts with said epoxy resin when said first layer and second layer of said first and second type of structure comprising said system is further provided. Also a method for obtainment of such nano/microstructures and system is provided.

### BRIEF DESCRIPTION OF THE FIGURES

The figures whose brief explanations are herewith provided are solely intended for providing a better understanding of the present invention and are as such not intended to define the scope of protection or the context in which said scope is to be interpreted in the absence of the description.

FIG. 1 schematically demonstrates longitudinal cross-sections of a first type nano/microstructure (a) and a second type nano/microstructure (b) according to the present invention.

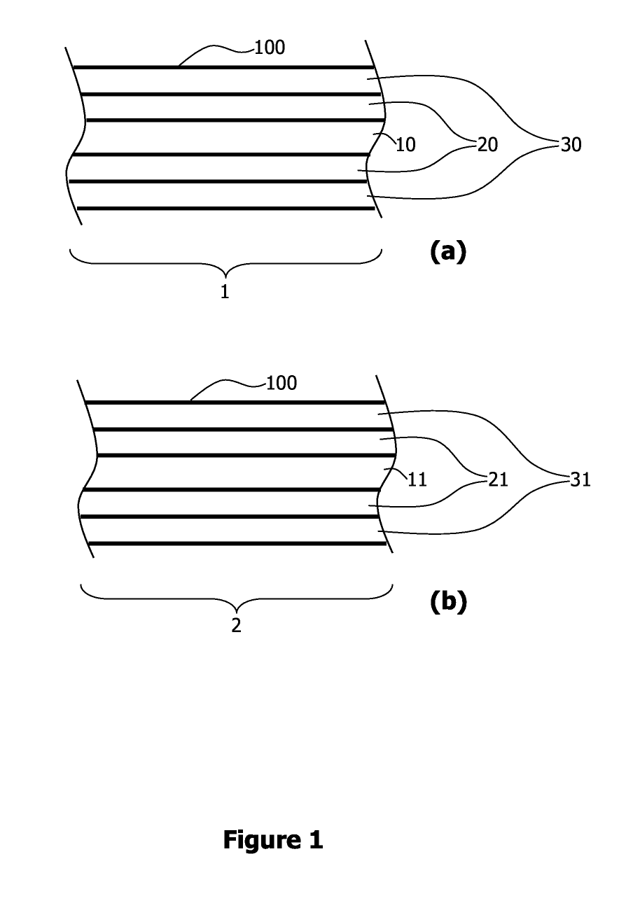

FIGS. 2(a) and (b) schematically represent several embodiments of nano/microstruetiifes according to the present invention; (a) with catalysts deposited on the outer surface thereon, (b) with catalysts embedded throughout the polymer matrix of the second layers thereof, and (c) with catalysts deposited/embedded on the outer surface as well as throughout the polymer matrix of the second layer thereof.

### DETAILED DESCRIPTION OF THE INVENTION

Referring now to the figures outlined above, the present invention proposes a system of nano/microstructures comprising a first type 1 and a second type 2 of longitudinal nano/microstructures each having an outer surface 100, each having a core 10, 11 and a polymeric first layer 20, 21 coaxially surrounding said core, and at least one of said longitudinal nano/microstructures comprising a catalyst 101; wherein the core 10 of said first type nano/microstructure 1 comprises an epoxy resin, and the core 11 of said second type nano/microstructure 2 comprises a hardener; each of said first and second type nano/microstructures further comprise a second layer 30, 31 coaxially surrounding said first layer 20, 21 wherein the stiffness of said second layer is higher than the stiffness of said first layer, and said hardener reacts with said epoxy resin when said first layer and second layer of said first and second type of nano/microstructures 1, 2 rupture upon a mechanical damage. Since, in case of rupture, said cores 10, 11 of both types of nano/microstructures leak and come in contact with each other.

The present invention further proposes a method for obtainment of such nano/microstructures 1, 2 and system of nano/microstructures.

The core 10 of said first type nano/microstructure 1 may comprise a single type of epoxy resin or a mixture of several epoxy resins. For an easy flow of resin towards a damaged zone when a system or a composite structure according to the present invention is damaged, a moderate viscosity is desired; hence, preferably low molecular weight thus low viscosity epoxy resin(s) are used in the core 10 of the first type nano/microstructure 1 according to the present invention.

Viscosities of the cores 10, 11 of both first and/or second type nano/microstructures 1, 2 can be controlled by addition of nanomaterials such as graphene. Also thinning solvents such as acetone can be employed in said cores 10, 11 for obtaining reduced

The core 10 of the first type nano/microstructures 1 preferably comprises a mixture of bisphenol A diglycidyl ether and a mineral oil. Bisphenol A diglycidyl ether is compatible with the polymer matrix of the second layer 30, thus stabilizes the mechanical integrity of the nano/microstructures 1 and fiber-reinforced self-healing composite structure employing said nano/microstructures.

The hardener which is comprised in the core 11 of said second type nano/microstructure 2 is preferably selected from the list consisting of thiols, aliphatic amines, cycloaliphatic amines, aromatic amines, anhydrides, phenols or a mixture thereof. By employing a hardener from said list, curing of epoxy resins can be achieved even at ambient temperatures. In a further preferred embodiment according to the present invention, the core 11 of the second type of nano/microstructures 2 comprises polyamine or ethylene diamine.

Since epoxy resins and thus the core 10 of the first type nano/microstructures 1 are hydrophobic, the core 11 of the second type nano/microstructures 2 should be hydrophobic as well for obtaining a rapid diffusion between two liquid mixtures of the cores 10, 11 in case of a damage. If the hardener has a rather high polarity thus a rather low hydrophobicity, the core 11 of the second type nano/microstructure 2 comprises at least a surfactant enhancing mixing said hardener into the fluid constituting said core 11.

For obtaining a clear and distinct boundary between the cores 10, 11 and respective first layers in contact with them 20, 21, the first layers 20, 21 are hydrophilic. This also provides an obstacle against any undesired reaction/dissolution event between said second layer 30, 31 and the core of said first and/or second type nano/microstructures. To that end, the first layer 20, 21 comprises one or more hydrophilic polymer preferably selected from the list consisting of polyacrylic acid, polyacrylamide and a copolymer thereof.

Likewise, for obtaining a clear and distinct boundary between the first layer 20, 21 and the second layer 30, 31, the second layer is hydrophobic by comprising one or more hydrophobic polymer, preferably including one or more materials selected from the group consisting of polystyrene, polyglycidyl methacrylate or polymethyl methacrylate or copolymers thereof.

In a preferred embodiment according to the present invention, the core 10, 11 of said first and/or second type nano/microstructures 1, 2 further comprises a viscosity controlling agent. In another preferred embodiment according to the present invention, the core 10, 11 of said first and/or second type nano/microstructures further comprises mineral oil.

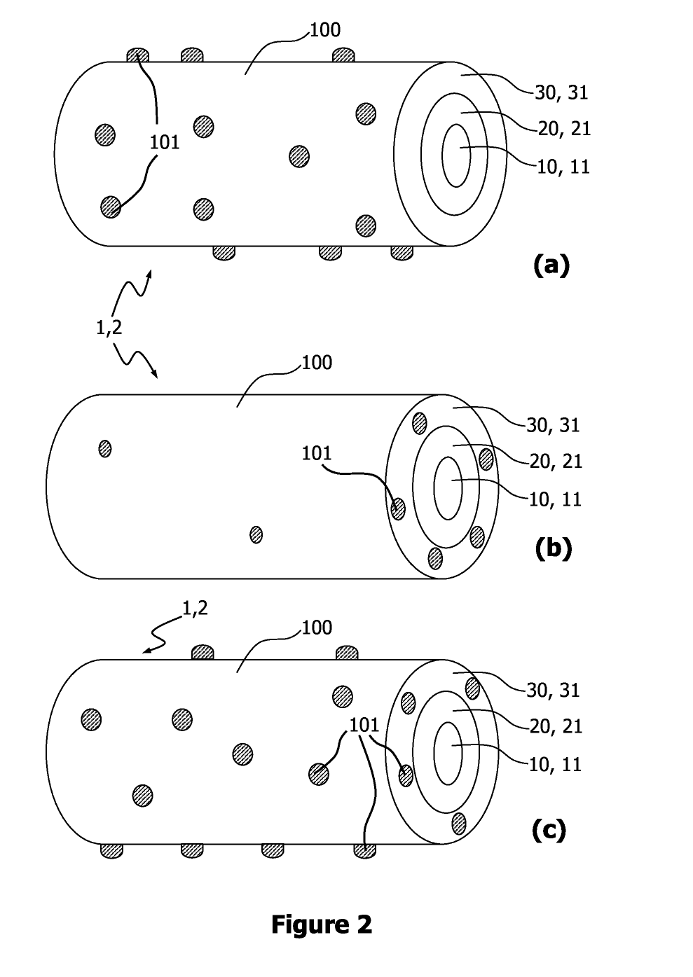

In an embodiment according to the present invention as shown in FIG. 2(a), the outer surfaces 100 of the first and/or second type nano/microstructures are provided with catalysts 101. This is preferably achieved as follows: said second layer 30, 31 preferably comprising epoxide functional groups, which undergo treatment by a reducing agent, and then metal catalysts are deposited thereon; thus said catalysts bond onto said outer surface, and nano/microstructures having outer surfaces provided with catalysts are obtained. Hence, in this embodiment, said outer surfaces 100 are provided with catalyst 101. In case of a local damage of a composite system employing the system of nano/structures according to the present invention, this embodiment allows the cores flowing to the location of damage where the materials constituting the cores of both first and second type nano/microstructures i.e. including epoxy resin and hardener encounter, mix and react with each other due to getting in contact with said catalyst on the outer surfaces of said nano/microstructures. This embodiment further allows low consumption of catalysts during the obtainment of said nano/microstructures.

In another embodiment according to the present invention as shown in FIG. 2(b), the second layer 30, 31 of the first and/or second type nano/microstructures 1, 2 are provided with embedded catalyst 101 throughout the polymer matrix of said second layer 30, 31. Said catalyst is preferably selected from a list consisting of alkali metal salts, amine compounds and a mixture thereof. Said amine compound is preferably selected from the list consisting of 1,2-dimethyl imidazole, diamine, tertiary amines or a mixture thereof. Said alkali metal salt is preferably selected from the list consisting of alkali metal hydroxides, alkali metal carbonates, or a mixture thereof. The catalyst is preferably used in excess. Said second layer 30, 31 preferably comprises epoxide functional groups. Thus, in this embodiment, said second layers of said first type and second type of longitudinal nano/microstructures are provided with catalyst. In case of a local mechanical damage of a composite system employing the system of nano/structures according to the present invention, this embodiment allows the cores flowing to the location of damage where the materials constituting the cores of both first and second type nano/microstructures i.e. including epoxy resin and hardener encounter, mix and react with each other due to getting in contact with said catalyst on the fractured surfaces as well as the outer surfaces of said nano/microstructures.

In a preferred embodiment according to the present invention as shown in FIG. 2(c), the outer surface 100 of the second layer 30, 31 of the nano/microstructures 1, 2 is provided with catalyst 101, as well as catalyst is embedded into the polymer matrix of said second layer 30, 31.

In another preferred embodiment according to the present invention, the catalyst 101 is provided in the core 10, 11 of said first and/or second type nano/microstructures 1, 2 in a mixed manner. In this embodiment, the system according to the present invention can be provided with one or further layers coaxially surrounding said second layers of said nano/microstructures for adding any available physical or chemical property to said system; since the catalyst is not only on the second layer and thus not static; as a result, the catalyst can reach to a zone of damage by flowing along with the core(s). In case of a local damage of a composite system employing the system of nano/structures according to the present invention, this embodiment allows the cores to carry a highly sufficient amount of catalysts to the location of damage where the materials constituting the cores of both first and second type nano/microstructures flow, thus epoxy resin and hardener encounter, mix and react with each other in presence of said catalyst, with even more reduced limitations.

The present invention further proposes a self-healing composite structure comprising the self-healing system of nano/microstructures described above, wherein said first type and second type nano/microstructures 1, 2 coexist in mixed manner. By employing said the self-healing system of nano/microstructures into a layer and/or between layers of a composite structure, said composite structure shall be considered as a self-healing composite with the advantages provided by the present invention described throughout this description.

Said self-healing composite structure according to the present invention preferably comprises catalyst distributed in vicinity of said nano/microstructures 1, 2 for enhancing the healing performance in case of a mechanical damage.

A method is provided for obtaining longitudinal nano/microstructures 1, 2 and self-healing system of nano/microstructures each having an outer surface 100, each having a core 10, 11 and a polymeric first layer 20, 21 coaxially surrounding said core and at least one of said longitudinal nano/microstructures comprising a catalyst 101, wherein the core of said first type nano/microstructure comprises an epoxy resin, and the core of said second type nano/microstructure comprises a hardener; each of said first and second type nano/microstructures further comprise a second layer 30, 31 coaxially surrounding said first layer wherein the stiffness of said second layer is higher than the stiffness of said first layer, and said hardener reacts with said epoxy resin when said first layer and second layer of said first and second type of nano/microstructures rupture upon a mechanical damage; said method comprising the following features:

a) Providing a hydrophobic fluid mixture comprising epoxy resin for feeding as a core of a first immiscible coaxial fluid stream,

b) Providing a hydrophobic fluid mixture comprising hardener for feeding as a core of a second immiscible coaxial fluid stream,

c) Providing a hydrophilic fluid mixture for feeding as a polymeric hydrophilic first layer of said first and second immiscible coaxial fluid streams,

d) Providing a hydrophobic fluid mixture for feeding as a polymeric hydrophobic second layer of said first and second immiscible coaxial fluid streams;

e) Providing a first immiscible coaxial fluid stream comprising
a hydrophobic core comprising epoxy resin of the step ‘a)’, a hydrophilic polymeric first layer of the step ‘c)’ coaxially surrounding said core and being chemically inert against said core, and a hydrophobic polymeric second layer of the step‘d)’ coaxially surrounding said first layer and being chemically inert against said first layer,
through a multi-axial spinneret which is connected to a pole of an electrospinning setup;

f) Contemporaneously providing a second immiscible coaxial fluid stream
comprising a hydrophobic core comprising a hardener of the step ‘b)’, a hydrophilic polymeric first layer of the step ‘c)’ coaxially surrounding said core and being chemically inert against said core, and a hydrophobic polymeric second layer of the step ‘d)’ coaxially surrounding said first layer and being chemically inert against said first layer,
through a multi-axial spinneret which is also connected to said pole of said electrospinning setup,

g) Collecting said both first and second streams on a surface on a collector of said electrospinning setup,

h) Addition of a catalyst to said first and/or second type of nano/microstructures after or at any of the above steps.

At the end of the step ‘g)’, said first and second streams already constitute a system of nano/microstructures of a first type 1 and a second type 2 of longitudinal nano/microstructures each having an outer surface 100 and each having a core and a polymeric first layer coaxially surrounding said core, wherein the core 10 of said first type nano/microstructure 1 comprise epoxy resin and the core 11 of said second type nano/microstructure 2s comprise hardener, and further wherein first and second layers of both said first and second streams are polymerized.

In a preferred embodiment according to the present invention, the fluid mixture of the step‘d)’ comprises polymers synthesized by radical polymerization of at least one monomer selected from the list consisting of vinyl, acryl and allyl, said monomers having at least one of the groups selected from the list consisting of oxirane, cyclic ether, thio ether, cyclic amine and cyclic anhydride, and wherein said addition of catalyst is performed upon said step ‘g)’, by contacting the outer surface of said first and/or second type nano/microstructures with catalysts in presence of a reducing agent.

In another preferred embodiment according to the present invention, said addition of catalyst is performed at the step ‘d)’, by adding one or more catalyst to said hydrophobic fluid mixture.

In another preferred embodiment according to the present invention, said addition of catalyst is performed at the step ‘a)’ by adding one or more catalyst to said hydrophobic fluid mixture comprising epoxy resin; and/or the at the step ‘b)’ by adding one or more catalyst to said hydrophobic fluid mixture comprising hardener. Thus providing said core of the first or second type nano/microstructures with catalyst.

Structural Health Monitoring (SHM) technology can be used to monitor the system for damage and fatigue conditions of the prepared nano/microstructures. Optical Fiber Bragg Grating (FBG) sensors can be embedded together within the second layer of the nano/microstructures according to the present invention. With these sensors, self-healing mechanism can be investigated under different loadings (fatigue, bending, shrinking, pressing) and any changes in displacement, strain, and temperature can be measured.

Hence, below objects are achieved by the present invention:
to overcome the abovementioned shortcomings of the prior art.
to provide coaxially multilayered longitudinal nano/microstructures with enhanced stiffness.
to provide a self-healing system having enhanced stability and self-healing
to provide a method to obtain such self-healing system.

1. A self-healing system of nano/microstructures comprising a first type and a second type of longitudinal nano/microstructures each having an outer surface, each having a core and a polymeric first layer coaxially surrounding said core and at least one of said longitudinal nano/microstructures comprising a catalyst, wherein
the core of said first type nano/microstructure comprises an epoxy resin, and
the core of said second type nano/microstructure comprises a hardener;
each of said first and second type nano/microstructures further comprises a second layer coaxially surrounding said first layer wherein the stiffness of said second layer is higher than the stiffness of said first layer, and
said hardener reacts with said epoxy resin when siad first layer and second layer of said first and second type of nano/microstructures rupture upon a mechanical damage.

2) A system according to the claim 1, wherein said first and/or second type nano/microstructures further comprises one or more layers coaxially surrounding said second layers.

3) A system of nano/microstructures according to the claim 1, wherein said catalyst is provided on the outer surface of said first and/or second type nano/microstructures.

4) A system according to the claim 1, wherein said catalyst is embedded throughout the polymer matrix of the second layer of said first and/or second type nano/microstructures.

5) A system according to the claim 1, wherein said catalyst is provided in the core of said first and/or second type nano/microstructures in a mixed manner.

6) A system of nano/microstructures according to the claim 1, wherein said catalyst is selected from the list consisting of alkali metal salts, amine compounds, and a mixture thereof.

7) A system according to the claim 1, wherein said first layer comprises one or more polymer selected from the list consisting of polyacrylic acid, polyacrylamide and a copolymer thereof.

8) A system according to the Claim 1, wherein said second layer comprises one or more polymer selected from the list consisting of polystyrene, polymethyl methacrylate, polyglycidyl methyl methacrylate and copolymers thereof.

9) A system according to the claim 1, wherein said epoxy resin is a low molecular weight epoxy resin.

10) A system according to the claim 1, wherein said hardener is selected from the list consisting of thiols, aliphatic amines, cycloaliphatic amines, aromatic amines, anhydrides, phenols or a mixture thereof.

11) A self-healing composite structure comprising the system of nano/microstructures according to the claim 1, wherein said first type and second type nano/microstructures coexist in mixed manner.

12) A method for obtaining longitudinal nano/microstructures and self-healing system of nano/microstructures each having an outer surface, each having a core and a polymeric first layer coaxially surrounding said core and at least one of said longitudinal nano/microstructures comprising a catalyst, wherein the core of said first type nano/microstructure comprises an epoxy resin, and the core of said second type nano/microstructure comprises a hardener; each of said first and second type nano/microstructures further comprise a second layer coaxially surrounding said first layer wherein the stiffness of said second layer is higher than the stiffness of said first layer, and said hardener reacts with said epoxy resin when said first layer and second layer of said first and second type of nano/microstructures rupture upon a mechanical damage; wherein said method comprising the following features:
a) Providing a hydrophobic fluid mixture comprising epoxy resin for feeding as a core of a first immiscible coaxial fluid stream,
b) Providing a hydrophobic fluid mixture comprising hardener for feeding as a core of a second immiscible coaxial fluid stream,
c) Providing a hydrophilic fluid mixture for feeding as a polymeric hydrophilic first layer of said first and second immiscible coaxial fluid
d) Providing a hydrophobic fluid mixture for feeding as a polymeric hydrophobic second layer of said first and second immiscible coaxial fluid streams;
e) Providing a first immiscible coaxial fluid stream comprising
a hydrophobic core comprising epoxy resin of the step ‘a)’, a hydrophilic polymeric first layer of the step ‘c)’ coaxially surrounding said core and being chemically inert against said core, and a hydrophobic polymeric second layer of the step ‘d)’ coaxially surrounding said first layer and being chemically inert against said
through a multi-axial spinneret which is connected to a pole of an electrospinning setup;
f) Contemporaneously providing a second immiscible coaxial fluid
comprising a hydrophobic core comprising a hardener of the step ‘b)’, a hydrophilic polymeric first layer of the step ‘c)’ coaxially surrounding said core and being chemically inert against said core, and a hydrophobic polymeric second layer of the step ‘d)’ coaxially surrounding said first layer and being chemically inert against said first layer,
through a multi-axial spinneret which is also connected to said pole of said electrospinning setup,
g) Collecting said both first and second streams as a product on a surface on a collector of said electrospinning setup,
h) Addition of one or more catalyst after or at any of the above steps.

13) A method according to the claim 12, wherein the fluid mixture of the step ‘d)’ comprises polymers synthesized by radical polymerization of at least one monomer selected from the list consisting of vinyl, acryl and allyl, said monomers having at least one of the groups selected from the list consisting of oxirane, cyclic ether, thio ether, cyclic amine and cyclic anhydride; and wherein said addition of catalyst is performed upon said step ‘g)’, by contacting the outer surface of said first and/or second type nano/microstructures with said catalyst in presence of a reducing agent.

14) A method according to the claim 12, wherein said addition of catalyst is performed at the step ‘d)’, by adding one or more catalyst to said hydrophobic fluid mixture.

15) A method according to the claim 12, wherein said addition of catalyst is performed at the step ‘a)’ by adding one or more catalyst to said hydrophobic fluid mixture comprising epoxy resin; and/or the at the step ‘b)’ by adding one or more catalyst to said hydrophobic fluid mixture comprising hardener.
